(19) United States
(12) Patent Application Publication
(10) Pub. No.: US 2026/0105408 A1
(43) Pub. Date: Apr. 16, 2026

(54) COMBINATORIAL OPTIMIZATION DEVICE, COMBINATORIAL OPTIMIZATION METHOD, AND COMPUTER PROGRAM

(71) Applicant: PANASONIC INTELLECTUAL PROPERTY MANAGEMENT CO., LTD., Osaka (JP)

(72) Inventors: Koichiro YAMAGUCHI, Osaka (JP); Eiichi ABE, Miyagi (JP); Hiroaki OMINATO, Miyagi (JP); Takahiro OHYAMA, Miyagi (JP)

(73) Assignee: PANASONIC INTELLECTUAL PROPERTY MANAGEMENT CO., LTD., Osaka (JP)

(21) Appl. No.: 19/124,940

(22) PCT Filed: Oct. 11, 2023
(86) PCT No.: PCT/JP2023/036879

§ 371 Date: Nov. 20, 2025

(30) Foreign Application Priority Data
Nov. 4, 2022 (JP) 2022-177300

(51) Int. Cl. G06Q 10/0834; G06Q 10/083

(52) U.S. Cl. CPC G06Q 10/08345; G06Q 10/0843

(57) ABSTRACT

According to the present invention, a more realistic and usable delivery plan is generated using a quantum computer. This combinatorial optimization device includes a control unit which is communicably connected to a quantum computer, wherein the control unit: adds a first constraint term specifying a time point relating to a delivery, and a second constraint term for leveling a workload of each vehicle to a cost function used to search for routes when a plurality of vehicles are to visit a plurality of delivery destinations; and causes the quantum computer to perform a quantum calculation of the cost function with the first constraint term and the second constraint term added thereto.

### TECHNICAL FIELD

The present disclosure relates to a combinatorial optimization device, a combinatorial optimization computing method, and a computer program.

### BACKGROUND ART

A technique is known that solves a problem of determining a processing order of materials to be processed by formulating the processing order as a traveling salesman problem and converting the traveling salesman problem into an Ising model that can be used in a quantum computer (Patent Literature 1).

In addition, a technique is known that generates an optimization function related to a variable representing a quantum state for solving a vehicle routing problem of delivering a vehicle to a parking lot short in which vehicles are insufficient, under various types of constraints on staff members, vehicles, and parking lots (Patent Literature 2).

### CITATION LIST

### Patent Literature

Patent Literature 1: JP6954245B
Patent Literature 2: WO2021/176632

### SUMMARY OF INVENTION

### Technical Problem

Constraints at the time when solving a vehicle routing problem using a quantum computer in the related art are insufficient for generating a realistically available delivery plan.

The present disclosure has been made in view of the above-described situations in the related art, and an object of the present disclosure is to generate a more realistically available delivery plan using a quantum computer.

### Solution to Problem

The present disclosure provides a combinatorial optimization device. The combinatorial optimization device includes a control unit communicably connected to a quantum computer, in which the control unit adds, to a cost function used for searching for a route when a plurality of vehicles visit a plurality of delivery destinations, a first constraint term for specifying a delivery time and a second constraint term for balancing a workload of each vehicle, and causes the quantum computer to execute quantum computing for a cost function to which the first constraint term and the second constraint term are added.

In addition, the present disclosure provides a combinatorial optimization method of computing combinatorial optimization by a combinatorial optimization device communicably connected to a quantum computer. The method includes adding, to a cost function used for searching for a route when a plurality of vehicles visit a plurality of delivery destinations, a first constraint term for specifying a delivery time and a second constraint term for balancing a workload of each vehicle, and causing the quantum computer to execute quantum computing for a cost function to which the first constraint term and the second constraint term are added.

In addition, the present disclosure provides a computer program causing a combinatorial optimization device communicably connected to a quantum computer to execute a process of adding, to a cost function used for searching for a route when a plurality of vehicles visit a plurality of delivery destinations, a first constraint term for specifying a delivery time and a second constraint term for balancing a workload of each vehicle, and a process of causing the quantum computer to execute quantum computing for a cost function to which the first constraint term and the second constraint term are added.

These comprehensive or specific aspects may be implemented by a system, a device, a method, an integrated circuit, a computer program, or a recording medium, and may be implemented by any combination of the system, the device, the method, the integrated circuit, the computer program, and the recording medium.

### Advantageous Effects of Invention

According to the present disclosure, it is possible to generate a more realistically available delivery plan using a quantum computer.

### BRIEF DESCRIPTION OF DRAWINGS

FIG. 1 is a diagram illustrating an example of a business flow related to delivery according to the present embodiment;

FIG. 2 is a block diagram illustrating a configuration example of a combinatorial optimization system according to the present embodiment;

FIG. 3 is a diagram illustrating a first term of (Formula 18) according to the present embodiment;

FIG. 4 is a flowchart illustrating processing executed by a combinatorial optimization device according to the present embodiment;

FIG. 5 is a diagram illustrating an arrangement example of delivery destinations according to the present embodiment;

FIG. 6 is a diagram illustrating a first example of delivery time specification according to the present embodiment;

FIG. 7 is a diagram illustrating a second example of the delivery time specification according to the present embodiment;

FIG. 8 is a diagram illustrating a first example of a delivery route according to the present embodiment; and

FIG. 9 is a diagram illustrating a second example of the delivery route according to the present embodiment.

### DESCRIPTION OF EMBODIMENTS

Hereinafter, an embodiment in which a combinatorial optimization device, a combinatorial optimization computing method, and a computer program according to the present disclosure are specifically disclosed will be described in detail with reference to the drawings as appropriate. However, unnecessarily detailed description may be omitted. For example, the detailed description of already well-known matters and the repeated description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### BACKGROUND

In recent years, efforts have been made to eliminate waste in an entire supply chain and reduce energy usage as a contribution to carbon neutral. A problem of optimizing the supply chain includes, for example, a vehicle routing problem (VRP) of searching for an efficient route when a plurality of vehicles visit a plurality of delivery destinations. The vehicle routing problem is a combinatorial optimization problem that is difficult to solve by a currently used computer (for example, a classical computer). Therefore, a method using quantum computing has been attracting attention as a new computing technique.

A classical bit used in the classical computer is only 0 or 1. On the other hand, a quantum bit used in a quantum computer can simultaneously represent a value obtained by combining 0 and 1. Therefore, with N quantum bits, all possible states of N classical bits can be represented simultaneously, and a large computing problem can be solved exponentially. By utilizing such a feature, the quantum computer can solve a specific problem at a very high speed. The combinatorial optimization problem is one of problems for which quantum computing is expected to enable efficient computing by representing an enormous number of combinations in quantum bits.

Quantum annealing is a method for solving the combinatorial optimization problem by quantum computing. It is expected that a solution to the combinatorial optimization problem can be obtained at a high speed by using quantum annealing.

However, in order to apply this solution to a real problem, it is necessary to deal with various constraints such as a specification of a delivery time at each delivery destination. In addition, when there is no solution that satisfies all constraints, it is necessary to generate an available solution while adjusting a degree of compliance with the constraints. Hereinafter, a problem related to creation of a delivery plan and a technique for solving the problem will be described using a specific example.

### Present Embodiment

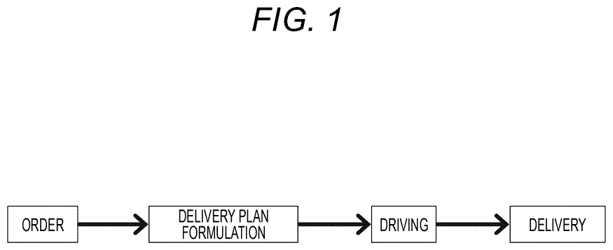

An example of a business flow related to delivery will be described with reference to FIG. 1. FIG. 1 is a diagram illustrating an example of the business flow related to the delivery according to the present embodiment.

For example, a customer orders a product from a WEB via the Internet or orders a product by visiting a store. The ordered product is delivered to a location designated by the customer (for example, a customer's home). The package (product) to be delivered is not limited to the product purchased by the customer.

A management computer that manages delivery receives information on an order (hereinafter, referred to as order information) (order). The order information includes, for example, an address of a delivery destination of the ordered product, information on the package to be delivered (for example, a name of the package, an identification number associated with the package, or the like), an amount of the package to be delivered (for example, a size or a weight of the package, or the like), a time when the customer orders the product, a time when the package is scheduled to be delivered, or the like. Further, the management computer acquires information on a vehicle that delivers the package (hereinafter, referred to as vehicle information). The vehicle information includes, for example, the number of vehicles, an upper load limit of the package of each vehicle, and an available operation time of each vehicle.

The management computer creates a delivery plan using the order information of the package to be delivered and the vehicle information of the vehicle that delivers the package (delivery plan formulation).

The vehicle delivers the package to the delivery destination based on the delivery plan created by the management computer (driving).

When arriving at the delivery destination, a deliverer in the vehicle delivers the package to the customer (delivery).

In this way, the management computer creates the delivery plan in order to efficiently deliver the package. However, it is difficult to use the management computer, which is the classical computer, to create a work plan that efficiently manages a total travel distance and a total travel time of a delivery vehicle, that complies with a delivery condition (for example, the upper load limit of the vehicle, a delivery deadline, or the like), and that prevents significant workload imbalance among the deliverers.

In view of the above-described situations in the related art, in the present disclosure, a formulation method for solving the vehicle routing problem including a more realistic constraint by using quantum computing will be described.

### <Description of System Configuration>

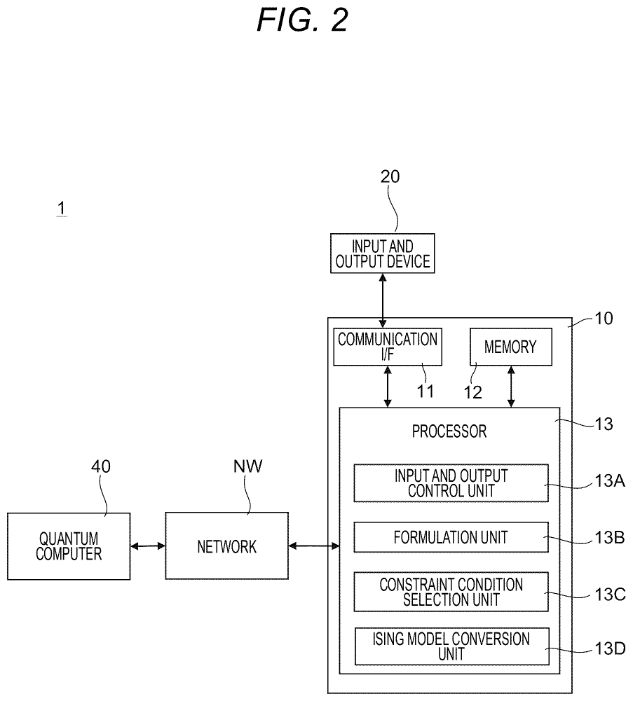

Next, a configuration example of a combinatorial optimization system will be described with reference to FIG. 2. FIG. 2 is a block diagram illustrating the configuration example of the combinatorial optimization system according to the present embodiment.

The combinatorial optimization system 1 includes an input and output device 20, a combinatorial optimization device 10, and a quantum computer 40.

The combinatorial optimization device 10 is the classical computer. The combinatorial optimization device 10 includes a communication I/F 11, a memory 12, and a processor 13. The I/F represents an interface. The combinatorial optimization device 10 is communicably connected to the input and output device 20. The combinatorial optimization device 10 is communicably connected to the quantum computer 40 via a network NW. The combinatorial optimization device 10 may be directly and communicably connected to the quantum computer 40, and in this case, the network NW may be omitted from the combinatorial optimization system 1.

The communication I/F 11 is a network interface circuit for the combinatorial optimization device 10 to execute wireless or wired communication with another device. In an example in FIG. 2, the another device is the input and output device 20. The communication I/F 11 is connected to the network NW and communicates with the quantum computer 40. Examples of the network NW include an Internet network, a wired local area network (LAN), a wireless LAN, long term evolution (LTE), 4G, and 5G. The input and output device 20 is connected to the communication I/F 11 in a wired or wireless manner. Examples of this connection method include a wired cable, the wired LAN, the wireless LAN, and short-range wireless communication (for example, Bluetooth (registered trademark)).

The memory 12 includes, for example, at least a read only memory (ROM) that stores a computer program for defining various processes executed by the processor 13 and data used during execution of the computer program, and a random access memory (RAM) serving as a work memory used when the various processes executed by the processor 13 is executed. In the ROM, the computer program for defining the various processes executed by the processor 13 and the data used during the execution of the computer program are written. In the RAM, data or information generated or acquired by the processor 13 (for example, a formula generated by a formulation unit 13B) is temporarily stored. The memory 12 temporarily stores information on a delivery object (for example, an identification number, a weight, a size, a delivery destination, or a delivery deadline of the delivery object). A storage destination of the information may be a storage medium such as a flash memory, a hard disk drive (HDD), or a solid state drive (SSD). In addition, the storage destination of the information may be a server device external to the combinatorial optimization device 10, and the combinatorial optimization device 10 may execute processing to read data from the external server device when the device is started up.

The processor 13 implements functions of an input and output control unit 13A, the formulation unit 13B, a constraint condition selection unit 13C, and an Ising model conversion unit 13D. The processor 13 is implemented using a semi-conductor chip on which at least one of electronic devices such as a central processing unit (CPU), a digital signal processor (DSP), a graphical processing unit (GPU), and a field programmable gate array (FPGA) is mounted. The processor 13 functions as a controller that controls an overall operation of the combinatorial optimization device 10, and executes a control process for controlling an operation of each unit of the combinatorial optimization device 10, a data input and output process between the units of the combinatorial optimization device 10, a data computing process, and a data storage process.

The processor 13 implements functions of the input and output control unit 13A, the formulation unit 13B, the constraint condition selection unit 13C, and the Ising model conversion unit 13D by using the program and the data stored in the ROM of the memory 12. The processor 13 uses the RAM of the memory 12 during an operation to temporarily store, in the RAM of the memory 12, data or information generated or acquired by the processor 13 and the units.

The input and output control unit 13A outputs, to the communication I/F 11, an instruction for outputting a formulated formula generated by the formulation unit 13B or information on a coefficient included in the formula (specifically, values related to an interaction and a local magnetic field in Formula (1)) to the quantum computer 40. The input and output control unit 13A outputs, to the communication I/F 11, an instruction for causing a display device 30 to output a result derived by the quantum computer 40.

When solving a combinatorial optimization problem using the quantum computer 40, the formulation unit 13B formulates a problem to be solved as an Ising model or a quadratic unconstrained binary optimization (QUBO). A specific formulation process executed by the formulation unit 13B will be described later.

The constraint condition selection unit 13C selects whether at least one (that is, a plurality of) constraint conditions required for solving the combinatorial optimization problem are treated as hard constraints or soft constraints. The hard constraint and the soft constraint will be described later.

The Ising model conversion unit 13D converts the combinatorial optimization problem formulated by the formulation unit 13B into an Ising model that can be used by the quantum computer 40. This function may be implemented on the quantum computer 40.

The quantum computer 40 is a quantum computer that executes quantum computing by a quantum annealing method. The quantum computer 40 is disposed on a cloud and is communicably connected to the combinatorial optimization device 10 via the network NW. The quantum computer 40 may not be disposed on the cloud, and may be disposed under a local environment and directly connected to the combinatorial optimization device 10. The quantum computer 40 may be, for example, a CPU, a GPU, a DSP, a FPGA, or an optical Ising machine, which executes a process of simulating a behavior of a quantum computer. Further, the quantum computer 40 may be a general-purpose quantum computer in which a quantum algorithm for implementing combinatorial optimization is implemented.

The input and output device 20 is a device that receives an input from an administrator (for example, a person who intends to obtain an optimal delivery plan using the quantum computer 40). The input and output device 20 is, for example, a mobile terminal, a tablet, or a personal computer (PC). The input and output device 20 receives, from the administrator, an input of information on a package to be delivered. The input and output device 20 is connected to a network, and may acquire information related to a product purchase performed by a user, and automatically input the information to the combinatorial optimization device 10.

The input and output device 20 outputs the delivery plan computed by the quantum computer 40. The display device 30 is, for example, a display. The display device 30 may display an error, for example, when the quantum computer 40 cannot derive the delivery plan.

### <Outline of Combinatorial Optimization Problem>

Combinatorial optimization using quantum computing will be described below.

When the combinatorial optimization problem is solved by quantum computing, it is necessary to formulate a problem to be solved as an Ising model or a QUBO. A general Ising model formulation is illustrated below.

$$\begin{matrix}[ Math . 1 ] & \\ H = - {\sum }_{i < j} {J}_{ij} {σ}_{i} {σ}_{j} - {\sum }_{i} {h}_{i} {σ}_{i} & ( Formula 1 )\end{matrix}$$

Here, σ ∈ {+1, −1} indicates a direction of the spin, Jᵢⱼ indicates a magnitude of an interaction between σᵢ and σⱼ, and hi indicates a local magnetic field acting on σᵢ. H represents energy of a field where all spins exist, and is called Hamiltonian. In the above-described formula, a QUBO formulation is obtained by replacing a with a bit σ ∈ {+1, −1} from the spin, and the Ising model and the QUBO are essentially equal.

In the combinatorial optimization using quantum computing, a state of each a that minimizes the Hamiltonian H, that is, a ground state is searched. Therefore, it is necessary to execute formulation such that an optimal solution to a target problem is in the ground state. An optimization result is obtained by inputting information on the formulated interaction and local magnetic field to a combinatorial optimization algorithm running on a quantum annealing machine or a general-purpose quantum computer.

The VRP according to the present disclosure is a problem of finding a route set having a minimal total travel distance among route sets in which each delivery destination is visited exactly once.

A QUBO formulation for the VRP in which the number of vehicles is specified is illustrated below.

$$\begin{matrix}[ Math . 2 ] & \\ f ( x ) := {\sum }_{v = 1}^{V} {\sum }_{s = 0}^{N} {{\sum }^{N}}_{{s}^{′} = 0} {\sum }_{t = 1}^{T} {d}_{{ss}^{′}} {y}_{s , n}^{v} {y}_{{s}^{′} , n + 1}^{v} - λ {\sum }_{v = 1}^{V} {\sum }_{s \neq {s}^{′}} ( {\sum }_{t = 1}^{T} {tx}_{st}^{v} - {\sum }_{t = 1}^{T} {tx}_{{s}^{′} t}^{v} ) ( {\sum }_{n = 0}^{N} n {y}_{sn}^{v} - {\sum }_{n = 0}^{N} n {y}_{{s}^{′} n}^{v} ) & ( Formula 2 )\end{matrix}$$

Hereinafter, Formula 2 is referred to as a cost function. Here, v represents a vehicle, x^{v}_{s,t} represents a variable indicating that a vehicle v visits a delivery destination s at time t, y^{v}_{s,n} represents a variable indicating that the vehicle v visits the delivery destination s for the nth time, V represents the number of vehicles, s and s′ each represent a delivery destination, n and n′ each represent a delivery order, t and t′ each represent a delivery time, T represents the number of time slots, and N represents the number of delivery destinations. Here, d_{s,s′} is a travel distance between the delivery destinations s and s′. A first term is a term related to a distance cost associated with travel between the delivery destinations s and s′. A second term is a term for matching x and y delivery orders.

Next, constraints for obtaining appropriate results x and y as solutions to the VRP are illustrated below. Here, n^{t}_{ss′} represents a shortest travel time between s and s′ at the time when departing from the delivery destination s at time t. (Formula 3) is a formula indicating the prohibition of travel from s to s′ in a required time smaller than n^{t}_{ss′}.

$$\begin{matrix}[ Math . 3 ] & \\ {\sum }_{v = 1}^{V} {\sum }_{s = 0}^{N} {{\sum }^{N}}_{{s}^{′} = 0} {\sum }_{t = 1}^{T} {\sum }_{δ = 1}^{{n}_{{ss}^{′}}^{t} - 1} {x}_{st}^{v} {x}_{{s}^{′} t + δ}^{v} = 0 & ( Formula 3 )\end{matrix}$$

(Formula 4) and (Formula 5) are each a formula indicating that the vehicle cannot be present at another delivery destination at the same time.

$$\begin{matrix}[ Math . 4 ] & \\ {\sum }_{v = 1}^{V} {\sum }_{t = 1}^{T} {\sum }_{s = 0}^{N - 1} {{\sum }^{N}}_{{s}^{′} = s + 1} {x}_{st}^{v} {x}_{{s}^{′} t}^{v} = 0 & ( Formula 4 )\end{matrix}$$

$$\begin{matrix}[ Math . 5 ] & \\ {\sum }_{v = 1}^{V} {\sum }_{n = 1}^{N} {\sum }_{s = 0}^{N - 1} {{\sum }^{N}}_{{s}^{′} = s + 1} {y}_{sn}^{v} {y}_{{s}^{′} n}^{v} = 0 & ( Formula 5 )\end{matrix}$$

(Formula 6) and (Formula 7) are each a formula indicating that all vehicles depart from a base (s=0).

$$\begin{matrix}[ Math . 6 ] & \\ \begin{matrix}{x}_{0 , 1}^{v} - 1 = 0 & ( 1 \leq v \leq V )\end{matrix} & ( Formula 6 )\end{matrix}$$

$$\begin{matrix}[ Math . 7 ] & \\ \begin{matrix}{y}_{0 , 0}^{v} - 1 = 0 & ( 1 \leq v \leq V )\end{matrix} & ( Formula 7 )\end{matrix}$$

(Formula 8) and (Formula 9) are each a formula indicating that each delivery destination is visited once.

$$\begin{matrix}[ Math . 8 ] & \\ \begin{matrix}{\sum }_{v = 1}^{V} {\sum }_{t = 1}^{T} {x}_{st}^{v} - 1 = 0 & ( 1 \leq s \leq N )\end{matrix} & ( Formula 8 )\end{matrix}$$

$$\begin{matrix}[ Math . 9 ] & \\ \begin{matrix}{\sum }_{v = 1}^{V} {\sum }_{n = 1}^{N} {y}_{s , n}^{v} - 1 = 0 & ( 1 \leq s \leq N )\end{matrix} & ( Formula 9 )\end{matrix}$$

(Formula 10) and (Formula 11) are each a formula indicating that only consecutive numbers are allowed for the delivery order.

$$\begin{matrix}[ Math . 10 ] & \\ {\sum }_{v = 1}^{V} \{ {\sum }_{n = 0}^{N - 1} {( {\sum }_{s = 0}^{N} {y}_{s , n}^{v} - {\sum }_{s = 0}^{N} {y}_{s , n + 1}^{v} - {b}_{n}^{v} )}^{2} + {( {\sum }_{s = 0}^{N} {y}_{s , N}^{v} - {b}_{N}^{v} )}^{2} \} = 0 & ( Formula 10 )\end{matrix}$$

Here, b^{v}ₙ is a variable added to make the delivery order consecutive.

$$[ Math . 11 ]$$

$${\sum }_{v = 1}^{V} {( {\sum }_{n = 0}^{N} {b}_{n}^{v} - 1 )}^{2} = 0 \qquad ( Formula 11 )$$

(Formula 12) is a formula indicating that the delivery destinations of the vehicles are matched in x and y.

$$[ Math . 12 ]$$

$${\sum }_{v = 1}^{V} {\sum }_{s = 0}^{N} {( {\sum }_{t = 1}^{T} {x}_{st}^{v} - {\sum }_{n = 0}^{N} {y}_{sn}^{v} )}^{2} = 0 \qquad ( Formula 12 )$$

A solution that satisfies all the constraints in (Formula 3) to (Formula 12) is referred to as a feasible solution. When a minimum value of a left-hand side of any of (Formula 3), (Formula 4), (Formula 5), (Formula 10), (Formula 11), and (Formula 12) is 0 (zero), the left-hand side is directly added to the cost function (Formula 2) to form a constraint term. On the other hand, when a minimum value of a left-hand side is not 0 (zero) as in (Formula 6), Formula 7), (Formula 8), and (Formula 9), a square of the left-hand side is added to the cost function (Formula 2) to form a constraint term.

The constraint term formed in this way takes a minimum value only for a solution that satisfies all the constraints. Therefore, by executing quantum annealing using a Hamiltonian obtained by adding the constraint term to the cost function, it is possible to preferentially search for a solution that satisfies all the constraints.

Next, additional constraints for satisfying requirements of a more realistic vehicle routing problem will be described below. (Formula 13) is a formula indicating that delivery is permitted only at a specified time shown below.

$$( {\hat{T}}_{s}^{( min )} \leq t \leq {\hat{T}}_{s}^{( max )} ) \qquad [ Math . 13 ]$$

Hereinafter, a constraint in (Formula 13) is referred to as “delivery time specification”.

$$[ Math . 14 ]$$

$$\begin{matrix}{\sum }_{v = 1}^{V} {\sum }_{s = 1}^{N} {\sum }_{t = 1}^{T} {F}_{st} {x}_{st}^{v} = 0 \\ {F}_{st} = \{ \begin{matrix}0 & ( {\hat{T}}_{s}^{( min )} \leq t \leq {\hat{T}}_{s}^{( max )} ) \\ min ( \vert {\hat{T}}_{s}^{( max )} - t \vert , \vert {\hat{T}}_{s}^{( min )} - t \vert ) & ( t < {\hat{T}}_{s}^{( min )} , {\hat{T}}_{s}^{( max )} < t )\end{matrix}\end{matrix} \qquad ( Formula 13 )$$

(Formula 14) is a formula indicating that delivery is prohibited after a time shown below delivery work is completed.

$$\hat{T} \qquad [ Math . 16 ]$$

Hereinafter, a constraint in (Formula 14) is referred to as “entire time specification”.

$$[ Math . 16 ]$$

$${\sum }_{v = 1}^{V} {\sum }_{s = 1}^{N} {\sum }_{t = 1}^{T} {T}_{t} {x}_{st}^{v} = 0 , {T}_{t} = \{ \begin{matrix}\hat{T} - t & ( t > \hat{T} ) \\ 0 & ( t \leq \hat{T} )\end{matrix} \qquad ( Formula 14 )$$

(Formula 15) is a formula indicating that the number of deliveries shown below of the vehicle v is fixed to an average value N/V.

$${\sum }_{t = 1}^{T} {\sum }_{s = 1}^{N} {x}_{st}^{v} \qquad [ Math . 18 ]$$

Hereinafter, a constraint in (Formula 15) is referred to as “balancing of the number of deliveries”.

$$[ Math . 18 ]$$

$$( {\sum }_{t = 1}^{T} {\sum }_{s = 1}^{N} {x}_{st}^{v} ) - \frac{N}{V} = 0 ( 1 \leq v \leq V ) \qquad ( Formula 15 )$$

(Formula 16) is a formula indicating that delivery of a package whose weight exceeds an upper load limit is prohibited. Hereinafter, a constraint in (Formula 16) is referred to as “package weight specification”.

$$[ Math . 19 ]$$

$${\sum }_{s = 1}^{N} {\sum }_{t = 1}^{T} {w}_{s} {x}_{st}^{v} \leq {C}_{v} ( 1 \leq v \leq V ) \qquad ( Formula 16 )$$

Here, wₛ is a variable related to the package weight to the delivery destination s. Cᵥ is an upper limit on the package weight of the vehicle v.

(Formula 17) is a formula indicating that a time difference between different vehicles u and v visiting a final delivery destination is set to 0 (zero). Hereinafter, a constraint in (Formula 17) is referred to as “balancing of final delivery time”.

$$[ Math . 20 ]$$

$${\sum }_{t = 0}^{T - 1} τ {z}_{t}^{v} - {\sum }_{τ = 1}^{T - 1} τ {z}_{st}^{v} = 0 ( 1 \leq v < v \leq V ) \qquad ( Formula 17 )$$

Here, z^{v}ₜ ∈ {0, 1} is a variable that is 1 only at the time t when the vehicle v visits the final delivery destination. In order to maintain a relation between x and z, a constraint term in the following (Formula 18) is added to the Hamiltonian.

$$[ Math . 21 ]$$

$${\sum }_{v = 1}^{V} [ {\sum }_{τ = 1}^{T - 1} \{ {\sum }_{i = 0}^{N} ( τ + 1 ) {x}_{i ( τ + 1 )}^{v} - {\sum }_{i = 0}^{N} τ {x}_{i τ}^{v} \} {z}_{τ}^{v} + {( {\sum }_{τ = 1}^{T} {z}_{τ}^{v} - 1 )}^{2} ] \qquad ( Formula 18 )$$

Here, i is a delivery destination, and x^{v}_{iτ} is a binary variable indicating 1 when the vehicle v visits a delivery destination i at time τ.

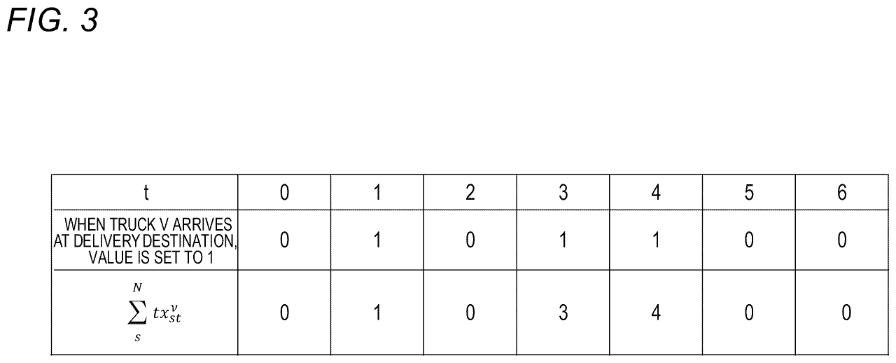

Here, (Formula 18) will be described with reference to FIG. 3. FIG. 3 is a diagram illustrating a first term of (Formula 18).

A table illustrated in FIG. 3 is a table for illustrating the first term of (Formula 18). Since a coefficient t is maximum at the final delivery destination, z° t also becomes 1 at that time. A second term is a term related to a constraint that the final delivery destination can be visited at only one time.

The above-described (Formula 13), (Formula 14), (Formula 15), (Formula 16), and (Formula 17) exhibit an effect by being added to the Hamiltonian as constraint terms. Since (the minimum value of the left-hand side) is 0 (zero) in each of the entire time specification in (Formula 13) and the delivery time specification in (Formula 14), each left-hand side may be added to the Hamiltonian to form a constraint term.

Since (the minimum value of the left-hand side) is not 0 (zero) in each of the balancing of the number of deliveries in (Formula 15) and the balancing of final delivery time in (Formula 17), a square of each left-hand side is added to the Hamiltonian to form a constraint term. In a case of an inequality constraint illustrated in the package weight specification in (Formula 16), a slack variable b_{v,k} ∈ {0, 1} is added, and the following constraint term is used.

$$[ Math . 22 ]$$

$${\sum }_{v = 1}^{V} {( {\sum }_{s = 1}^{N} {\sum }_{t = 1}^{T} {w}_{s} {x}_{st}^{v} + {\sum }_{k = 1}^{D} {2}^{k - 1} {b}_{v , k} - {C}_{v} )}^{2} \qquad ( Formula 19 )$$

Here, wₛ is the package weight for the delivery destination s, and D is the number of bits of the slack variable and is a variable as illustrated below.

$${\sum }_{k = 1}^{D} {2}^{k - 1} {b}_{v , k} \leq {C}_{v} \qquad [ Math . 23 ]$$

Accordingly, when an upper load limit Cᵥ is equal to or larger than a penalty weight shown below, a difference is absorbed, and the quantum computer 40 can avoid an unintended penalty.

$${\sum }_{s = 1}^{N} {\sum }_{t = 1}^{T} {w}_{s} {x}_{st}^{v} \qquad [ Math . 24 ]$$

In recent years, a Constrained Quadratic Models (CQM) solver that searches for a solution having a minimum cost from feasible solutions that satisfy all constraints has appeared. The CQM solver searches for a solution that completely satisfies all the constraints. That is, when the CQM solver is used, the quantum computer 40 treats all the constraints as hard constraints. The hard constraint is a constraint condition treated as a constraint required to be satisfied by the quantum computer 40. Therefore, in a situation where there is no feasible solution that satisfies all the constraints, the quantum computer 40 cannot intentionally output a solution that can be used in an actual operation. Even in such a case, if the quantum computer 40 can output a solution with as few violations as possible by relaxing the conditions of the additional constraints, the quantum computer can re-create a plan by changing a parameter such as the number of vehicles with reference to this solution at the site. In addition, even in a situation where the quantum computer 40 has to select an inefficient route due to the additional constraints, a very efficient solution is likely to be obtained by relaxing the conditions. In consideration of such a situation, the conditions of the additional constraints are relaxed such that a solution violating the constraint condition can be searched for using the CQM solver. That is, the combinatorial optimization device 10 selects whether to treat the constraint condition as the soft constraint. The soft constraint is a constraint condition under which the quantum computer 40 allows constraint deviation and controls and handles a deviation magnitude.

In order to realize the soft constraint, the combinatorial optimization device 10 changes the constraint to allow slight constraint violation from the conditions of the additional constraints. Hereinafter, relaxation into the soft constraint will be described using the delivery time specification as an example.

(Formula 13) that defines the hard constraint of the delivery time specification is an equation, but can be converted to an inequality constraint by an allowable upper limit Fₘₐₓ. That is, this means that the combinatorial optimization device 10 sets an allowable upper limit on “total deviation from the specified time” regarding the delivery destinations of all the vehicles.

$$[ Math . 25 ]$$

$${\sum }_{v = 1}^{V} {\sum }_{s = 1}^{N} {\sum }_{t = 1}^{T} {F}_{st} {x}_{st}^{v} \leq {F}_{max} \qquad ( Formula 20 )$$

Thus, by taking the total deviation from the specified time regarding the delivery destinations of the vehicles, some elements greatly deviate from the constraint while limiting total violation, and thus the quantum computer 40 may derive an efficient solution. The quantum computer 40 may derive an efficient solution by adding the following constraint term to the Hamiltonian using the slack variable b_{v,k}^{(F)} as in (Formula 19).

### (Soft Constraint Term for Delivery Time Specification)

$$[ Math . 26 ]$$

$${\{ ( {\sum }_{v = 1}^{V} {\sum }_{s = 1}^{N} {\sum }_{t = 1}^{T} {F}_{st} {x}_{st}^{v} ) - {F}_{max} + {\sum }_{k = 1}^{{C}_{F}} {2}^{k - 1} {b}_{v , k}^{( F )} \}}^{2} \qquad ( Formula 21 )$$

Here, D_{F} is a number as illustrated below.

$${\sum }_{k = 1}^{{D}_{F}} {2}^{k - 1} {b}_{v , k}^{( F )} \leq {F}_{max} \qquad [ Math . 27 ]$$

Here, Fₘₐₓ is an allowable limit on total penalty. b_{v,k}^{(F)} is a slack variable that absorbs a difference between the total penalty regarding the vehicle v and the upper limit Fₘₐₓ, and k is a bit index. By applying the same procedure to other hard constraints as in (Formula 21), the hard constraint can be relaxed into a soft constraint as described below.

### (Soft Constraint Term for Entire Time Specification)

$$[ Math . 28 ]$$

$${\{ ( {\sum }_{v = 1}^{V} {\sum }_{s = 1}^{N} {\sum }_{t = 1}^{T} {F}_{st} {x}_{st}^{v} ) - {F}_{max} + {\sum }_{k = 1}^{{C}_{F}} {2}^{k - 1} {b}_{v , k}^{( F )} \}}^{2} \qquad ( Formula 22 )$$

Here, Tₘₐₓ is an allowable limit on total penalty due to exceeding an upper delivery time limit. b_{v,k}^{(T)} is a slack variable that absorbs a difference between the total penalty regarding the vehicle v and the upper limit Tₘₐₓ. D_{T} is the number of bits of b_{v,k}(^{T}). k is a bit index.

### (Soft Constraint Term for Balancing of the Number of Deliveries)

$$[ Math . 29 ]$$

$${\sum }_{v = 1}^{V} {( ( \frac{N}{V} - {V}_{v} ) - {\sum }_{t = 1}^{T} {\sum }_{s = 1}^{N} {x}_{st}^{v} + {\sum }_{k = 1}^{{D}_{ni}} {2}^{k - 1} {b}_{v , k}^{( n 1 )} )}^{2} \qquad ( Formula 23 )$$

Here, Vᵥ is an allowable deviation range for the number of deliveries of the vehicle v from an average number of deliveries N/V b_{v,k}^{(nl)} is a slack variable that absorbs a difference between an actual number of deliveries of the vehicle v and a lower limit (N/V−Vᵥ). Dₙₗ is the number of bits of b_{v,k}^{(nl)}.

### (Soft Constraint Term for Package Weight Specification)

$${\sum }_{v = 1}^{V} {( {\sum }_{s = 1}^{N} {\sum }_{t = 1}^{T} {w}_{s} {x}_{st}^{v} + {\sum }_{k = 1}^{{D}_{F}} {2}^{k - 1} {b}_{v , k} - ( {C}_{v} + {μ}_{v} ) )}^{2} \qquad [ Math . 30 ]$$

Here, wₛ is a weight of the package for the delivery destination s. b_{v,k} is a slack variable that absorbs a difference between an actual load capacity of the vehicle v and the upper limit Cᵥ. Dᵥ is the number of bits of b_{v,k}. v, is a range in which loading exceeding the upper load limit Cᵥ is allowed in the vehicle v.

### (Soft Constraint Term for Balancing of Final Delivery Time)

$$[ Math . 31 ]$$

$$\begin{matrix}{{\sum }_{v = 1}^{V} {\sum }_{u = 1}^{V} {( {\sum }_{τ = 1}^{T} τ {z}_{τ}^{\ddot{v}} - {\sum }_{τ = 1}^{T} τ {z}_{τ}^{\ddot{u}} )}^{2} - ε + {\sum }_{k = 1}^{{D}_{ε}} {2}^{k - 1} b {ε}_{vu , k} )}^{2} \\ + {\sum }_{v = 1}^{V} [ {\sum }_{τ = 1}^{τ - 1} \{ {\sum }_{i = 0}^{N} ( τ + 1 ) {x}_{l ( τ + 1 )}^{v} - {\sum }_{i = 0}^{N} τ {x}_{i τ}^{v} \} {x}_{τ}^{v} + {( {\sum }_{τ = 1}^{T} {z}_{τ}^{v} - 1 )}^{2} ]\end{matrix} \qquad ( Formula 25 )$$

Here, τ is a time variable. z_{τ}^{v} is a binary variable indicating 1 when the vehicle v arrives at the final delivery destination at the time τ. z_{τ}^{u} is a binary variable indicating 1 when the vehicle u arrives at the final delivery destination at the time τ. ε is an upper limit on a difference in final delivery time between the two vehicles. D_{ε} is the number of bits of bεv_{u,k}. By setting shown in Math. 32, Math. 33 is realized. Accordingly, the slack variable is reduced.

$${\sum }_{k = 1}^{{D}_{F}} {2}^{k - 1} {b}_{v , k}^{( F )} \leq 2 e \qquad [ Math . 32 ]$$

$$- ε \leq ( {\sum }_{τ = 1}^{T} τ {z}_{τ}^{v} - {\sum }_{τ = 1}^{T} τ {z}_{τ}^{u} ) \leq ε \qquad [ Math . 33 ]$$

Here, the constraint of the delivery time specification and the constraint of the entire time specification form a first constraint term for specifying a delivery time. The constraint of the balancing of the number of deliveries and the constraint of the balancing of final delivery time form a second constraint term for balancing a workload of the vehicle.

The combinatorial optimization device 10 causes the quantum computer 40 to execute quantum computing for the Hamiltonian formed by adding the first constraint term and the second constraint term to the cost function. The combinatorial optimization device 10 may cause the quantum computer 40 to execute quantum computing for the Hamiltonian formed by further adding the constraint term of the package weight specification in addition to the first constraint term and the second constraint term.

### (Processing Executed by Combinatorial Optimization Device 10)

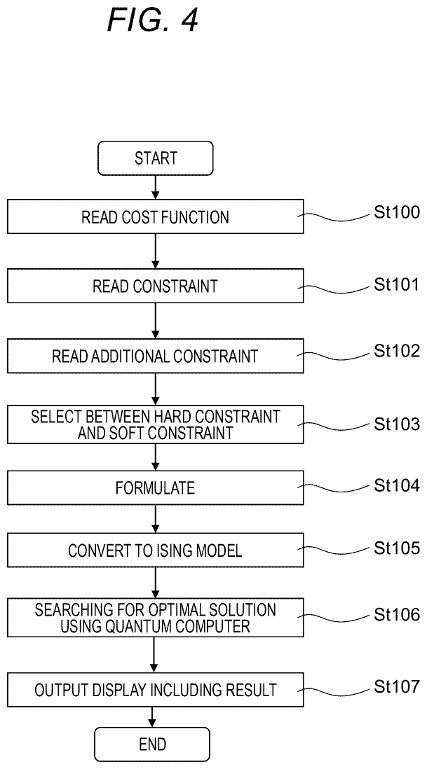

Next, processing executed by the combinatorial optimization device will be described with reference to FIG. 4. FIG. 4 is a flowchart illustrating the processing executed by the combinatorial optimization device 10. Processes in the flowchart in FIG. 4 are executed by the combinatorial optimization device 10.

The formulation unit 13B of the combinatorial optimization device 10 reads the cost function from the memory 12 (step St100).

The formulation unit 13B of the combinatorial optimization device 10 reads the constraint from the memory 12 (step Stl01).

The formulation unit 13B of the combinatorial optimization device 10 reads at least one additional constraint from the memory 12 (step St102).

The constraint condition selection unit 13C of the combinatorial optimization device 10 selects whether the additional constraint read by the formulation unit 13B is a hard constraint or a soft constraint (step St103). The constraint condition selection unit 13C outputs a result selected in the process of step St103 to the formulation unit 13B.

The formulation unit 13B of the combinatorial optimization device 10 formulates a combinatorial optimization problem using the cost function read in the process of step St100, the constraint read in the process of step Stl01, the additional constraint read in the process of step St102, and the selection result acquired from the constraint condition selection unit 13C in the process of step St103 (step St104). The formulation unit 13B outputs the formula formulated in the process of step St104 to the Ising model conversion unit 13D.

The Ising model conversion unit 13D of the combinatorial optimization device 10 converts the formula formulated in the process of step St104 to an Ising model that can be used by the quantum computer 40 (step St106).

The combinatorial optimization device 10 outputs, to the quantum computer 40, the formula converted to the Ising model in the process of step St106 or information on a coefficient included in the formula. The quantum computer 40 executes quantum computing using the formula converted to the Ising model acquired from the combinatorial optimization device 10 or information thereof, and searches for an optimal solution. The quantum computer 40 outputs a result obtained by quantum computing to the combinatorial optimization device 10 (step St106).

The combinatorial optimization device 10 outputs, to the display device 30, the result obtained by quantum computing acquired in the process of step St106 for display (step St107).

Through the series of processes described above, the combinatorial optimization device 10 can derive a solution to the combinatorial optimization problem by using the quantum computer 40.

### Output Example

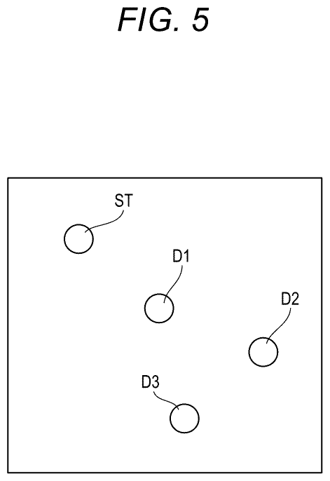

Next, an arrangement example of delivery destinations will be described with reference to FIG. 5. FIG. 5 is a diagram illustrating the arrangement example of the delivery destinations.

The location ST is a base from which delivery is started. The vehicle starts the delivery from the location ST.

A location D1, a location D2, and a location D3 indicate positions of the delivery destinations. The administrator considers a test case in which a delivery plan in which the vehicle departs from a location ST and delivers the package through all of the location D1, the location D2, and the location D3 is created using the quantum computer 40. Hereinafter, the location D1 is referred to as a delivery destination 1, the location D2 is referred to as a delivery destination 2, and the location D3 is referred to as a delivery destination 3.

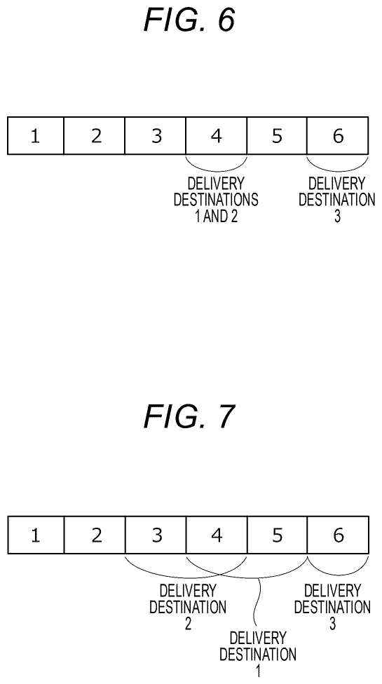

Next, an example of delivery time specification will be described with reference to FIGS. 6 and 7. FIG. 6 is a diagram illustrating a first example of the delivery time specification. FIG. 7 is a diagram illustrating a second example of the delivery time specification.

FIGS. 6 and 7 are each a diagram in which a total delivery time is divided into six time slots at predetermined time intervals.

In the example of the delivery time specification illustrated in FIG. 6, it is assumed that the delivery destination 1 and the delivery destination 2 allow delivery in time slot 4, and the delivery destination 3 allows delivery in time slot 6. In the delivery time specification illustrated in FIG. 6, since delivery to two locations is required at the same time, the combinatorial optimization device 10 cannot obtain, from the quantum computer 40, a solution that satisfies the hard constraint. In the example of the delivery time specification illustrated in FIG. 6, when the additional constraint is the soft constraint, the combinatorial optimization device 10 obtains a solution from the quantum computer.

In the example of the delivery time specification illustrated in FIG. 7, it is assumed that the delivery destination 2 allows delivery in time slot 3 and the time slot 4, the delivery destination 1 allows delivery in the time slot 4 and time slot 5, and the delivery destination 3 allows the delivery in the time slot 6.

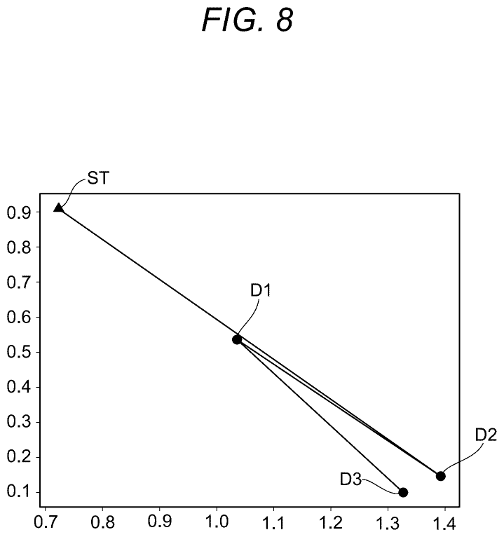

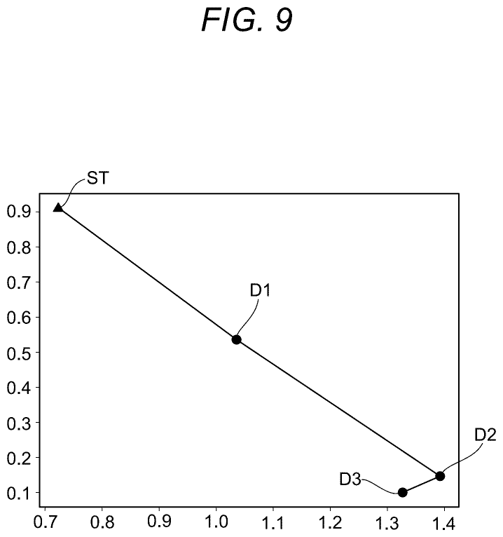

Next, an example of a delivery route will be described with reference to FIGS. 8 and 9. FIG. 8 is a diagram illustrating a first example of the delivery route. FIG. 9 is a diagram illustrating a second example of the delivery route. A vertical axis in each of the diagrams illustrated in FIGS. 8 and 9 is any numerical value indicating a position. A horizontal axis in each of the diagrams illustrated in FIGS. 8 and 9 is any numerical value indicating a position.

A graph illustrated in FIG. 8 is a route diagram corresponding to position information of the locations ST, D1, D2, and D3 illustrated in FIGS. FIG. 8 is a diagram of the delivery route obtained by the combinatorial optimization device 10 from the quantum computer 40 when delivery is performed according to the delivery time specification illustrated in FIG. 7 and the additional constraint is set as the hard constraint.

A graph illustrated in FIG. 9 is a route diagram corresponding to the position information of the locations ST, D1, D2, and D3 illustrated in FIG. 5. FIG. 9 is a diagram of the delivery route obtained by the combinatorial optimization device 10 from the quantum computer 40 when delivery is performed according to the delivery time specification illustrated in FIG. 6 and the additional constraint is set as the soft constraint. In the delivery route illustrated in FIG. 9, a route connecting the location D2 and the location D3 arranged adjacent to each other is included in the delivery route, and the combinatorial optimization device 10 obtains, from the quantum computer 40, an efficient route in which a total travel distance of the vehicle is reduced.

As described above, in a case in which there is no solution that satisfies all the constraints and in a case in which the quantum computer 40 derives the inefficient route due to the constraints, the combinatorial optimization device 10 sets the additional constraint as the soft constraint, and thus a more efficient route may be obtained from the quantum computer 40.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### (Summary of Present Disclosure)

The following techniques are disclosed based on the above-described description of the embodiment.

### <Technique 1>

A combinatorial optimization device (for example, the combinatorial optimization device 10) according to the present embodiment includes a control unit (for example, the processor 13) communicably connected to a quantum computer (for example, the quantum computer 409), in which the control unit adds a first constraint term for specifying a delivery time and a second constraint term for balancing a workload of each vehicle to a cost function used for searching for a route when a plurality of vehicles visit a plurality of delivery destinations, and causes the quantum computer to execute quantum computing for a cost function to which the first constraint term and the second constraint term are added.

Accordingly, the combinatorial optimization device according to the present embodiment can derive a solution that satisfies requirements of a realistic vehicle routing problem and satisfies all constraints by adding the first constraint term and the second constraint term. That is, the combinatorial optimization device can generate a more realistically available delivery plan using the quantum computer.

### <Technique 2>

In the combinatorial optimization device according to technique 1, the control unit selects, from the first constraint term and the second constraint term, a hard constraint that is an item required to be satisfied when the quantum computer executes quantum computing and a soft constraint that is an item capable of specifying a constraint deviation magnitude.

Accordingly, the combinatorial optimization device according to the present embodiment can derive, by making the hard constraint and the soft constraint selectable, an efficient solution even when there is no feasible solution that satisfies all the constraints.

### <Technique 3>

In the combinatorial optimization device according to technique 1 or technique 2, the first constraint term is an item related to a constraint for specifying delivery at a specified time. Accordingly, the combinatorial optimization device according to the present embodiment can derive a solution to the vehicle routing problem in accordance with a more realistic situation by adding the constraint for specifying the delivery at the specified time.

### <Technique 4>

In the combinatorial optimization device according to any one of techniques 1 to 3, the first constraint term is the following Formula 21.

$${\{ ( {\sum }_{v = 1}^{V} {\sum }_{s = 1}^{N} {\sum }_{t = 1}^{T} {F}_{st} {x}_{st}^{v} ) - {F}_{max} + {\sum }_{k = 1}^{{D}_{F}} {2}^{k - 1} {b}_{v , k}^{( F )} \}}^{2} \qquad [ Math . 34 ]$$

(Formula 21) Here, V is the number of vehicles, N is the number of deliveries, T is the number of time slots, Fₛₜ is a function related to an available delivery time at a delivery destination s, x^{v}ₛₜ is a binary variable indicating 1 when a vehicle v visits the delivery destination s at time t, Fₘₐₓ is an allowable limit on total penalty, b_{v,k}^{(F)} is a slack variable that absorbs a difference between the total penalty regarding the vehicle v and an upper limit Fₘₐₓ, D_{F} is the number of bits of b_{v,k}^{(F)} and k is a bit index.

Accordingly, the combinatorial optimization device according to the present embodiment can derive a solution to the vehicle routing problem in accordance with a more realistic situation by adding the constraint for specifying the delivery at the specified time.

### <Technique 5>

In the combinatorial optimization device according to any one of techniques 1 to 4, the first constraint term is an item related to a constraint for restricting delivery after a time at which a delivery work is completed.

Accordingly, the combinatorial optimization device according to the present embodiment can derive a solution to the vehicle routing problem in accordance with a more realistic situation by adding the constraint for restricting the delivery after the time at which the delivery work is completed.

### <Technique 6>

In the combinatorial optimization device according to any one of techniques 1 to 5, the first constraint term is the following Formula 22.

$$[ Math . 35 ]$$

$${\{ ( {\sum }_{v = 1}^{V} {\sum }_{s = 1}^{N} {\sum }_{t = 1}^{T} {T}_{t} {x}_{st}^{v} ) - {T}_{max} + {\sum }_{k = 1}^{{D}_{F}} {2}^{k - 1} {b}_{v , k}^{( T )} \}}^{2} \qquad ( Formula 22 )$$

Here, V is the number of vehicles, N is the number of deliveries, T is the number of time slots, Tₜ is a function related to a delivery time, x^{v}ₛₜ is a binary variable indicating 1 when a vehicle v visits a delivery destination s at time t, Tₘₐₓ is an allowable limit on total penalty due to exceeding an upper time limit, b_{v,k}^{(T)} is a slack variable that absorbs a difference between the total penalty regarding the vehicle v and an upper limit Tₘₐₓ, D_{T} is the number of bits of b_{v,k}(^{T}), and k is a bit index.

Accordingly, the combinatorial optimization device according to the present embodiment can derive a solution to the vehicle routing problem in accordance with a more realistic situation by adding the constraint for restricting the delivery after the time at which the delivery work is completed.

### <Technique 7>

In the combinatorial optimization device according to any one of techniques 1 to 6, the second constraint term is an item related to a constraint for specifying the number of deliveries of the vehicle as an average value obtained by dividing a total number of deliveries by a total number of vehicles.

Accordingly, the combinatorial optimization device according to the present embodiment can derive a solution to the vehicle routing problem in accordance with a more realistic situation by adding the constraint for specifying the number of deliveries of the vehicle as the average value that is a value obtained by dividing the total number of deliveries by the total number of vehicles.

### <Technique 8>

In the combinatorial optimization device according to any one of techniques 1 to 7, the second constraint term is the following Formula 23.

$$[ Math . 36 ]$$

$${\sum }_{v = 1}^{V} {( ( \frac{N}{V} - {V}_{v} ) - {\sum }_{t = 1}^{T} {\sum }_{s = 1}^{N} {x}_{st}^{v} + {{\sum }^{{D}_{n , i}}}_{k = 1} {2}^{k - 1} {b}_{v , k}^{( nl )} )}^{2} \qquad ( Formula 23 )$$

Here, V is the number of vehicles, N is the number of deliveries, T is the number of time slots, Vᵥ is an allowable deviation range for the number of deliveries of a vehicle v from an average number of deliveries N/V, x^{v}ₛₜ is a binary variable indicating 1 when the vehicle v visits a delivery destination s at time t, b_{v,k}^{(nl)} is a slack variable that absorbs a difference between an actual number of deliveries of the vehicle v and a lower limit (N/V−Vᵥ), Dₙₗ is the number of bits of b_{v,k}^{(nl)}, and k is a bit index.

Accordingly, the combinatorial optimization device according to the present embodiment can derive a solution to the vehicle routing problem in accordance with a more realistic situation by adding the constraint for specifying the number of deliveries of the vehicle as the average value that is a value obtained by dividing the total number of deliveries by the total number of vehicles.

### <Technique 9>

In the combinatorial optimization device according to any one of techniques 1 to 8, the second constraint term is an item related to a constraint for specifying a time difference between different vehicles visiting a final delivery destination as zero.

Accordingly, the combinatorial optimization device according to the present embodiment can derive a solution to the vehicle routing problem in accordance with a more realistic situation by adding the constraint for specifying the time difference between the different vehicles visiting the final delivery destination as zero.

### <Technique 10>

In the combinatorial optimization device according to any one of techniques 1 to 9, the second constraint term is the following Formula 25.

$$[ Math . 37 ]$$

$$\begin{matrix}{{\sum }_{v = 1}^{V} {\sum }_{u = 1}^{V} {( {\sum }_{τ = 1}^{T} τ {z}_{τ}^{v} - {\sum }_{τ = 1}^{T} τ {z}_{τ}^{u} )}^{2} - ε + {\sum }_{k = 1}^{{D}_{ε}} {2}^{k - 1} b {ε}_{vu , k} )}^{2} \\ + {\sum }_{v = 1}^{V} [ {\sum }_{τ = 1}^{τ - 1} \{ {\sum }_{i = 0}^{N} ( τ + 1 ) {x}_{i ( τ + 1 )}^{v} - {\sum }_{i = 0}^{N} τ {x}_{i τ}^{v} \} {z}_{τ}^{v} + {( {\sum }_{τ = 1}^{T} {z}_{τ}^{v} - 1 )}^{2} ]\end{matrix} \qquad ( Formula 25 )$$

Here, V is the number or vehicles, N is me number or deliveries, 1 is the number of time slots, i is a delivery destination, x^{v}_{iτ} is a binary variable indicating 1 when a vehicle v visits a delivery destination i at time τ, τ is a time variable, zτ^{v} is a binary variable indicating 1 when the vehicle v arrives at the final delivery destination at time τ, z_{τ}^{u} is a binary variable indicating 1 when a vehicle u arrives at the final delivery destination at the time τ, ε is an upper limit on a difference in the number of deliveries between two vehicles, k is a bit index, and D_{ε} is the number of bits of bε_{vu,k}.

Accordingly, the combinatorial optimization device according to the present embodiment can derive a solution to the vehicle routing problem in accordance with a more realistic situation by adding the constraint for specifying the time difference between the different vehicles visiting the final delivery destination as zero.

The present application is based on a Japanese Patent Application (Japanese Patent Application No. 2022-177300) filed on Nov. 4, 2022, and the contents thereof are incorporated herein by reference.

### INDUSTRIAL APPLICABILITY

The technique of the present disclosure is useful as a combinatorial optimization device that generates a more realistically available delivery plan using a quantum computer, a combinatorial optimization computing method, and a computer program.

### REFERENCE SIGNS LIST

10: combinatorial optimization device
11: communication I/F
12: memory
13: processor
13A: input and output control unit
13B: formulation unit
13C: constraint condition selection unit
13D: Ising model conversion unit
20: input and output device
40: quantum computer
NW: network
ST, D1, D2, D3: location

1. A combinatorial optimization device, comprising:
a control unit that is communicably connected to a quantum computer, wherein
the control unit adds, to a cost function used for searching for a route when a plurality of vehicles visit a plurality of delivery destinations, a first constraint term for specifying a delivery time and a second constraint term for balancing a workload of each vehicle, and causes the quantum computer to execute quantum computing for a cost function to which the first constraint term and the second constraint term are added.

2. The combinatorial optimization device according to claim 1, wherein
the control unit selects, from the first constraint term and the second constraint term, a hard constraint that is an item required to be satisfied when the quantum computer executes quantum computing and a soft constraint that is an item capable of specifying a constraint deviation magnitude.

3. The combinatorial optimization device according to claim 1, wherein
the first constraint term is an item related to a constraint for specifying delivery at a specified time.

4. The combinatorial optimization device according to claim 3, wherein
the first constraint term is the following Formula 21, and
$${\{ ( {\sum }_{v = 1}^{V} {\sum }_{s = 1}^{N} {\sum }_{t = 1}^{T} {F}_{st} {x}_{st}^{v} ) - {F}_{max} + {\sum }_{k = 1}^{{D}_{F}} {2}^{k - 1} {b}_{v , k}^{( F )} \}}^{2} \qquad ( Formula 21 )$$
V is the number of vehicles, N is the number of deliveries, T is the number of time slots, Fₛₜ is a function related to an available delivery time at a delivery destination s, x^{v}st is a binary variable indicating 1 when a vehicle v visits the delivery destination s at time t, Fₘₐₓ is an allowable limit on total penalty, b_{v,k}^{(F)} is a slack variable that absorbs a difference between the total penalty regarding the vehicle v and an upper limit Fₘₐₓ, D_{F} is the number of bits of b_{v,k}^{(F)}, and k is a bit index.

5. The combinatorial optimization device according to claim 1, wherein
the first constraint term is an item related to a constraint for restricting delivery after a time at which a delivery work is completed.

6. The combinatorial optimization device according to claim 5, wherein
the first constraint term is the following Formula 22, and
$${\{ ( {\sum }_{v = 1}^{V} {\sum }_{s = 1}^{N} {\sum }_{t = 1}^{T} {T}_{t} {x}_{st}^{v} ) - {T}_{max} + {\sum }_{k = 1}^{{D}_{F}} {2}^{k - 1} {b}_{v , k}^{( T )} \}}^{2} \qquad ( Formula 22 )$$
V is the number of vehicles, N is the number of deliveries, T is the number of time slots, Tₜ is a function related to a delivery time, x^{v}ₛₜ is a binary variable indicating 1 when a vehicle v visits a delivery destination s at time t, Tₘₐₓ is an allowable limit on total penalty due to exceeding an upper time limit, b_{v,k}^{(T)} is a slack variable that absorbs a difference between the total penalty regarding the vehicle v and an upper limit Tₘₐₓ, D_{T} is the number of bits of b_{v,k}(^{T}), and k is a bit index.

7. The combinatorial optimization device according to claim 1, wherein
the second constraint term is an item related to a constraint for specifying the number of deliveries of the vehicle as an average value obtained by dividing a total number of deliveries by a total number of vehicles.

8. The combinatorial optimization device according to claim 7, wherein
the second constraint term is the following Formula 23, and
$${\sum }_{v = 1}^{V} {( ( \frac{N}{V} - {V}_{v} ) - {\sum }_{t = 1}^{T} {\sum }_{s = 1}^{N} {x}_{st}^{v} + {{\sum }^{{D}_{n , i}}}_{k = 1} {2}^{k - 1} {b}_{v , k}^{( nl )} )}^{2} \qquad ( Formula 23 )$$
V is the number of vehicles, N is the number of deliveries, T is the number of time slots, Vᵥ is an allowable deviation range for the number of deliveries of a vehicle v from an average number of deliveries N/V, x^{v}ₛₜ is a binary variable indicating 1 when the vehicle v visits a delivery destination s at time t, b_{v,k}(nl) is a slack variable that absorbs a difference between an actual number of deliveries of the vehicle v and a lower limit (N/V−Vᵥ), Dₙₗ is the number of bits of b_{v,k}^{(nl)}, and k is a bit index.

9. The combinatorial optimization device according to claim 1, wherein
the second constraint term is an item related to a constraint for specifying a time difference between different vehicles visiting a final delivery destination as zero.

10. The combinatorial optimization device according to claim 9, wherein
the second constraint term is the following Formula 25, and
$$\begin{matrix}{{\sum }_{v = 1}^{V} {\sum }_{u = 1}^{V} {( {\sum }_{τ = 1}^{T} τ {z}_{τ}^{v} - {\sum }_{τ = 1}^{T} τ {z}_{τ}^{u} )}^{2} - ε + {\sum }_{k = 1}^{{D}_{ε}} {2}^{k - 1} b {ε}_{vu , k} )}^{2} \\ + {\sum }_{v = 1}^{V} [ {\sum }_{τ = 1}^{τ - 1} \{ {\sum }_{i = 0}^{N} ( τ + 1 ) {x}_{i ( τ + 1 )}^{v} - {\sum }_{i = 0}^{N} τ {x}_{i τ}^{v} \} {z}_{τ}^{v} + {( {\sum }_{τ = 1}^{T} {z}_{τ}^{v} - 1 )}^{2} ]\end{matrix} \qquad ( Formula 25 )$$
V is the number of vehicles, N is the number of deliveries, T is the number of time slots, i is a delivery destination, x^{v}_{iτ} is a binary variable indicating 1 when a vehicle v visits a delivery destination i at time τ, τ is a time variable, zₜ^{v} is a binary variable indicating 1 when the vehicle v arrives at the final delivery destination at time τ, z_{τ}^{u} is a binary variable indicating 1 when a vehicle u arrives at the final delivery destination at the time τ, ε is an upper limit on a difference in the number of deliveries between two vehicles, k is a bit index, and D_{ε} is the number of bits of bε_{vu,k}.

11. A combinatorial optimization method of computing combinatorial optimization by a combinatorial optimization device communicably connected to a quantum computer, the method comprising:
adding, to a cost function used for searching for a route when a plurality of vehicles visit a plurality of delivery destinations, a first constraint term for specifying a delivery time and a second constraint term for balancing a workload of each vehicle; and
causing the quantum computer to execute quantum computing for a cost function to which the first constraint term and the second constraint term are added.

12. A computer program causing a combinatorial optimization device communicably connected to a quantum computer to execute
a process of adding, to a cost function used for searching for a route when a plurality of vehicles visit a plurality of delivery destinations, a first constraint term for specifying a delivery time and a second constraint term for balancing a workload of each vehicle, and
a process of causing the quantum computer to execute quantum computing for a cost function to which the first constraint term and the second constraint term are added.
